(19) United States
(12) Patent Application Publication
(10) Pub. No.: US 2002/0106932 A1
(43) Pub. Date: Aug. 8, 2002

(54) Low profile electrical connector

(76) Inventors: Simon Holland, Edmunds (GB); Peter Bishop, Cambridgeshire (GB)

Correspondence Address: John E. Vick, Jr., Dority & Manning P.A., P.O. Box 1449, Greenville, SC, 29602, US

(21) Appl. No.: 09/777,712

(22) Filed: Feb. 6, 2001

(51) Int. Cl. H01R 3/00

(52) U.S. Cl. 439/500

(57) ABSTRACT

A low profile electrical connector for interconnecting electrical components in an electronic device is disclosed. In particular, a miniaturized electrical connector having deflectable contacts is provided. The electrical contact includes an elongated beam portion and a base portion. The elongated beam portion may include a plurality of cantilever beams which may be flexed together, or separately, from a undeflected position to a deflected position during engagement with an electronic component, such as a power pack or battery. The connector may include a conductive portion made of metal, and an insulator which is molded at one or more molding points into a base portion of the metal contacts. In one embodiment, a board to board connector is provided.

### FIELD OF THE INVENTION

The invention relates generally to electrical connectors for interconnecting electrical components. In particular, the invention is directed to a smaller, more compact and more efficient means for interconnecting electrical components in an electronic device.

### BACKGROUND OF THE INVENTION

In the manufacture of consumer electronic devices, there is a continuing need to minimize the size, and yet expand the capabilities, of such devices. Telephone handsets, for example, include an extraordinary number of components and sub-components in a relatively small and confined space. The handset of a radio telephone includes a microphone unit, a speaker unit, a dialing system, antenna components, and various circuitry including a variety of related and interconnecting components. In many cases, the handset may include a DC receptacle. Connectors typically are needed for any and all of these components and systems. Thus, a relatively large number of components, systems and connectors must be incorporated into a relatively small and rugged apparatus. There is an ever increasing desire to miniaturize telephone handsets, and particularly mobile telephone handsets. This creates a challenge to product designers to fit more components into a limited amount of space.

Battery packs provide a portable source of power for portable electronic devices. Such battery packs incorporate a plurality of batteries in a housing and usually provide common output power ports for powering various portable devices such as portable transceivers. Once a battery pack is discharged, the portable device is transported to a charging station where the battery pack is recharged. Then the recharged battery is re-inserted into the electronic device. Contacts on the electronic device interact with contact points on the battery to renew the electrical connection between the battery and the electronic device when the battery is re-inserted into the electronic device.

Contacts often include a fixed portion and a moveable portion, that is capable of moving or bearing against the fixed portion. Fixed contacts are relatively inexpensive to incorporate within a product as compared to movable contacts. Thus, it is customary to find fixed contacts employed on a battery to minimize the overall battery cost Such electrical contacts traditionally are formed using discreet contact elements that are electrically coupled to circuitry within the battery. Furthermore battery packs may receive rough treatment, and therefore product designers often employ fixed contacts on battery packs to minimize the risk of damage to such battery packs.

Movable contacts, on the other hand, are typically incorporated within the electrical interface on a host device. A movable contact tends to have more parts than a fixed contact, and thus is more expensive to incorporate into a product. Prior art approaches to movable contacts have included the use of pogo pins, cantilever contacts, springs, and the like. By incorporating such movable contacts upon the electronic device rather than upon the battery, the more expensive portion of the contact, which is the moveable portion, may be incorporated into the higher priced unit (i.e. the electronic device itself) rather than the lower priced battery pack. A user is likely to purchase several batteries for each electronic device, and it is often the case that by incorporating the less expensive component of the electrical interface upon the battery, the overall cost to the consumer may be reduced.

There exists a need in the industry to provide for the incorporation of improved fixed and movable contacts in an electrical interface between an electronic device and a removable electronic component. There is a need for a more efficient fixed and movable contacts in the use of removable batteries, power packs, and the like which are both reliable and cost effective. Furthermore, a more compact movable electrical contact that adequately adjusts for the tolerances needed to securely engage an electronic component is needed.

### SUMMARY OF THE INVENTION

The invention provides a low profile and compact electrical connector for interconnecting electrical components to each other. In particular, the invention comprises at least one electrical contact, the contact comprising an elongated beam portion and a base portion. The base portion is provided in a first plane, and the elongated beam portion is provided at a deviation angle from the first plane. The elongated beam portion has a first end and a second end, and is held in a fixed position at its first end near the base portion. An insulator is molded into the base portion of the contact. The base portion of the contact is secured to the insulator of a plurality of molding points. Further, at least part of the elongated beam portion of the electrical contact is flexibly sprung at a deviation angle from the first plane of the base portion. The second end of the elongated beam portion is adapted for flexible engagement with an electrical component.

The invention finds particular utility in small electronic devices, such as consumer electronic devices. Furthermore, the invention is useful in connection with hand held electronic devices, such as radio telephones which use a battery pack. The electrical interface includes contacts that are located within a housing of an electronic device. The low profile electrical connector is anchored into an electronic device where it becomes available for interaction with a second electronic component, such as a battery pack or similar power unit.

In one application of the invention, a plurality of cantilever beams are arranged in parallel, each cantilever beam having a first end and a second end. The second end of the beams is adapted to flexibly engage an electronic component. A first end of the cantilever beams is secured to a base portion. Furthermore, the insulator is molded into the base portion of the contact using insert molding techniques which securely lodge plastic or thermoplastic material of the insulator into intimate connection with the base portion of the contact. The insulator may comprise parallel struts separated by channels, the channels being adapted to provide a pathway for the elongated beams to flex when they are contacted by an electronic component. The elongated beams are flexed from a first undeflected position to a second deflected position. In some applications, the electrical contact is comprised of a metal. One metal that may be used is beryllium copper. The insulator may be comprised of essentially any insulating material. Materials that may be used for the insulator include thermoplastics and other non-metallics. The electrical contact might be molded as part of the insulator, and subsequently plated to provide a conductive surface.

In one aspect of the invention, cantilevered beams are capable of flexing within the channels from a location at which they are essentially parallel with the first plane of the base to a second location at which they are held from further movement by a stop. In one embodiment of the invention, a cantilever beam is pre-loaded with tension such that the cantilever beam is held against the stop in the undeflected position, and then moved away from the stop when receiving pressing contact from the terminal of an electronic component, such as a battery pack device. In one aspect of the invention, the cantilever beams are capable of flexing independently from one another, but other embodiments may provide cantilever beams which flex in unison as a single unit.

In yet another embodiment of the invention, an electrical connector which is capable of interconnecting at least a first circuit board to a second circuit board is provided. This “board to board” connector provides an insulating body base portion having an upper portion defining an uppermost face that is configured for this position adjacent a bottommost face. Furthermore, longitudinal sides are provided. A plurality of connector elements are disposed on said connector, and each connector element comprises a first end and a second end. A contact foot defined generally at the second end, and extending from the uppermost face, is also provided. The contact foot is disposed for contact mounting to a first circuit board. A generally horizontally mounted portion which is intermediate and adjacent to the first end and is mounted for contact with a second circuit board is provided as well. A resiliently movable contact head is defined generally at the first end of the connector element, and moves towards the uppermost first face upon being pressed into mating contact with the first circuit board. Further, at least a part of the connector element portion is flexibly sprung at an angle from the plane of the base portion, the connector element being adapted to flex while engaging a first circuit board. Further, the insulating body base portion is molded to the connector element at at least one molding point.

### BRIEF DESCRIPTION OF THE DRAWINGS

A full and enabling disclosure of this invention, including the best mode shown to one of ordinary skill in the art, is set forth in this specification. The following Figures illustrate the invention:

FIG. 1 shows a perspective view of the low profile connector of the invention;

FIG. 2 depicts a top view of the low profile connector which is previously seen in FIG. 1;

FIG. 2A reveals a bottom view of the connector shown in FIGS. 1-2;

FIG. 3 shows a side view of the connector shown in FIG. 2A;

FIG. 4 shows an end view of the connector seen in FIGS. 1-3;

FIG. 5A shows a side view of the low profile connector with a beam that is undeflected;

FIG. 5B shows a side view of the low profile connector with a beam that is fully deflected;

FIG. 5C shows a side view of a connector in which the beam is partially deflected, such that the contact nose and the retention feature coincide at the deflected position;

FIG. 6 shows a perspective view of the retention feature of the low profile battery connector;

FIG. 7 is an alternate embodiment of the invention including a perspective view of a low profile stacker type connector;

FIG. 8 shows an end view of the connector seen in FIG. 7; and

FIG. 9 reveals a side cross-sectional veiw of the connector shown in FIG. 8, in which the connector is shown with metal molded to plastic or thermoplastic in a rugged, slim structure.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention, which broader aspects are embodied in the exemplary constructions.

The insulator portion of the apparatus of the invention may be comprised of a thermoplastic or a plastic material. In the invention, metallic contacts are insert molded into the insulator. In that process, contacts are stamped and separated, then clamped into a mold into which liquid plastic or thermoplastic is injected. When released from the mold, the resulting connector unit is mechanically strong.

The insulator may be comprised of essentially any plastic or thermoplastic that is non-conductive. In some cases, when the connector is to be soldered in a reflow type soldering process, the thermoplastic or plastic material from which the insulator is made must be capable of withstanding the higher temperatures it may experience during the reflow soldering technique. For connectors which are not soldered, it is possible to use plastic having a lower glass transition temperature, which may be less costly per unit.

In one preferred embodiment, contacts are comprised of metallic material. A metal that works well in single beam type contacts of the present invention is beryllium copper, which is adapted for providing good flexibility in the cantilever beam embodiment. In general, the invention may find utility in any portable device in which it is required that there be a separate battery pack. Examples of devices into which the invention might be employed include, but are not limited to, the following: hand held cellular telephones, personal digital assistant devices, bar code scanners, personal mobile radios (such as those used by security forces), GPS global positioning systems, and the like.

Insert molding pursuant to the invention employs the basic principle of introducing an insert molded part into a mold tool cavity and subsequently shooting plastic around the insert molded part. In the case of the invention, considerable skill in the art of component design and tooling design and manufacture must be exercised to achieve the accurate shutoffs required between the inserted device and the mold tool, such shutoffs usually being a prerequisite to the success of small and intricate connector devices, and the free travel of their moving parts.

In general terms, the less space that is taken up by the connector, the more space is available for other components. Further, miniaturization is faciliated by the practice of the invention. The invention may use insert molding techniques down to stack heights of as low as 0.3 mm or even lower. A typical range for stack height is between about 0.3 and about 2.5 mm.

By the nature of its low profile, the connector provides a relatively small degree of movement of the contact. Since the force exerted by the contact increases with contact travel, some preload or pretravel is experienced in the contact at the point of molding to achieve reasonable operating forces for relatively small degrees of contact movement when engaged with the mating device, i.e. a battery pack. Such reasonable operating forces can be on the order of about 100 gmsf, and such pretravel can be on the order of about 0.5 mm, or perhaps in the range of about 0.1 mm to about 1.3 mm.

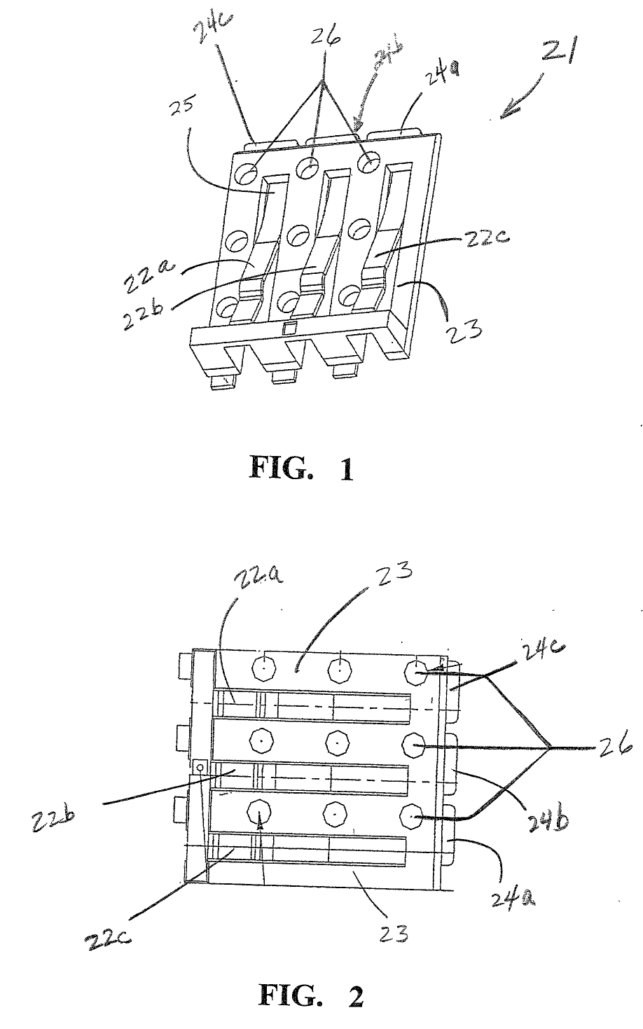

In FIG. 1, a low profile connector 21 is provided in perspective view. Although many variations of the connector could be envisioned by one of skill in the art, FIG. 1 shows but one example of such a connector that is within the spirit and scope of the invention.

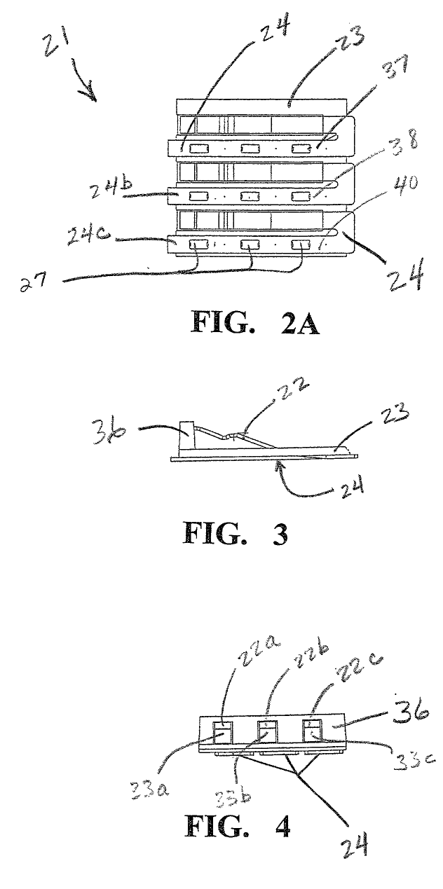

Elongated contact beam portions 22a, 22b, and 22c are shown in parallel extending from one end of the low profile connector 21 towards the other end. The elongated contact beams 22a-c are provided generally in parallel, but in other embodiments they may not be in parallel. Furthermore, any number of elongated contact beams can be used, and there is no practical limit to the number of beams that could be used in practice of the invention. The elongated contact beams 22a-c are continuous with the base portion 24a-c of the contact which is seen near the top of FIG. 1, but it may be seen more clearly in FIG. 2A. Basically, the low profile connector 21 comprises an insulative portion represented for example by insulator 23, and a metallic portion. The metallic portion usually includes one or more elongated contact beams, such as beams 22a-c shown in FIG. 1, which are in unison with a base portion 24a-c of a contact. The base portion is provided in a first plane, and the elongated beam portion is provided at a deviation angle from the first plane, which will be seen more clearly in FIG. 3. Furthermore, the insulator is usually molded into the metallic base portion of the contact, whereby the base portion of the contact is fixed, or secured, to the insulator at a plurality of molding points which will be discussed below.

A first end 25 of the elongated beam contact portion is shown in FIG. 1. Clamping pin apertures 26 are seen in FIG. 1, and in that particular embodiment there are a total of about nine clamping pin apertures on the surface of the insulator 23. These apertures facilitate the use of clamping pins passing through the mold tool cavity and clamping the contact against the opposite face of the mold tool. In this way, the contact part is well sealed against the mold cavity and provides for the ingress of plastic under this surface. Furthermore, the insulator 23 is secured in a fixed manner to the elongated contact beams 22a-c at one or more molding points 27, as seen in FIG. 2A.

In FIG. 2, a top view of the connector of FIG. 1 is shown, with the plastic insulator 23 shown imposed above a base portion 24 of the contact. Sometimes, the embodiment shown in FIGS. 1-2 is called a “three-way” low profile battery connector, in part because there are three elongated contact beams in that particular embodiment.

FIG. 2A shows the bottom view of the low profile connector 21 which was shown previously in FIGS. 1-2. In the bottom view, it is important to note the molding points 27 shown along the surface of the base portion 24 of the contact. First parallel strip 37, second parallel strip 38, and third parallel strip 40 each comprise three molding points along their surface as shown in the Figure. Thus, there are a total of nine molding points on the lower surface of the low profile connector 21 shown in FIG. 2A.

In the practice of the invention, the number of molding points may vary from one to as many as twenty or thirty, or even more as necessary to effect the required integrity of the assembly of the contact portion to the insulator portion. This will depend upon the number of points needed in order to obtain a tight fit between the insulator 23 and the elongated contact beam 22. Furthermore, the geometry of the connector will be important in determining the amount of molding points which are needed or desirable in a given configuration. In general, the molding points are sites at which a plastic or thermoplastic material from which the insulator 23 is comprised is allowed to penetrate, in liquid or semi-liquid form into holes or apertures which have previously been placed in the base portion 24 of the contact for receiving such liquified plastic material. In other embodiments, it would be possible (and perhaps useful) to envelop the base portion 24 entirely in plastic. In this way, a connector having both metallic components and plastic or thermoplastic components may be joined in a secure manner but using a minimum amount of space and volume to achieve a maximum amount of strength and flexibility in the low profile connector 21.

In FIG. 3, the low profile connector 21 of FIG. 2A is seen in side view, showing the base portion 24 which is provided on the underside, and the insulator 23 on the upper surface. The elongated contact beam 22 is manufactured in such a way that the elongated contact beam 22 is sprung with a tensioning force against the stop 36 portion of the insulator 23. In this way, each of the elongated contact beams 22a and 22b-c (22b-c not shown in FIG. 3) are aligned when seen in an end view as shown in FIG. 3. Correct alignment of these is important and helpful in providing for a plurality of flexible elongated contact beams 22a-c to receive a battery pack or other electronic component when it is inserted for secure connection. The practice of positioning is also helpful in achieving viable contact forces in a very low profile, and hence a “short contact travel” style connector.

In FIG. 4, the stop 36 portion of the insulator is seen in end view, showing the elongated contact beams 22a-c each sprung with a pre-loaded force upon the upper surface of the channels 33a-c, respectively, located in the stop 36. Furthermore, the base portion 24 of the contact is seen at the lower portion of FIG. 4.

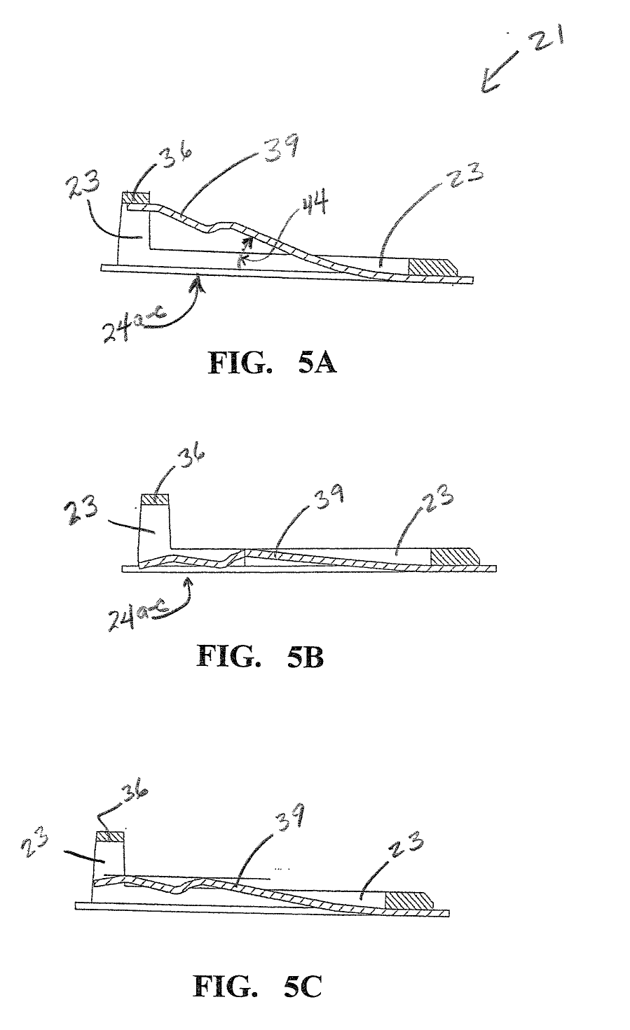

In FIG. 5A, the low profile connector 21 is seen in its undeflected mode, whereby the beam 39 (sometimes called a cantilever beam) is pre-loaded, and sprung against stop 36. The beam 39 is provided at a deviation angle 44 which preferably is about the same for each beam of the low profile connector 21.

Further, FIG. 5B shows the beam 39 in the completely deflected position, whereby it is pushed down against the base portion 24 of the contact and is substantially (but not quite) parallel with the plane of the base portion 24 of the contact. FIG. 5C shows the beam 39 at the point at which it is partly deflected.

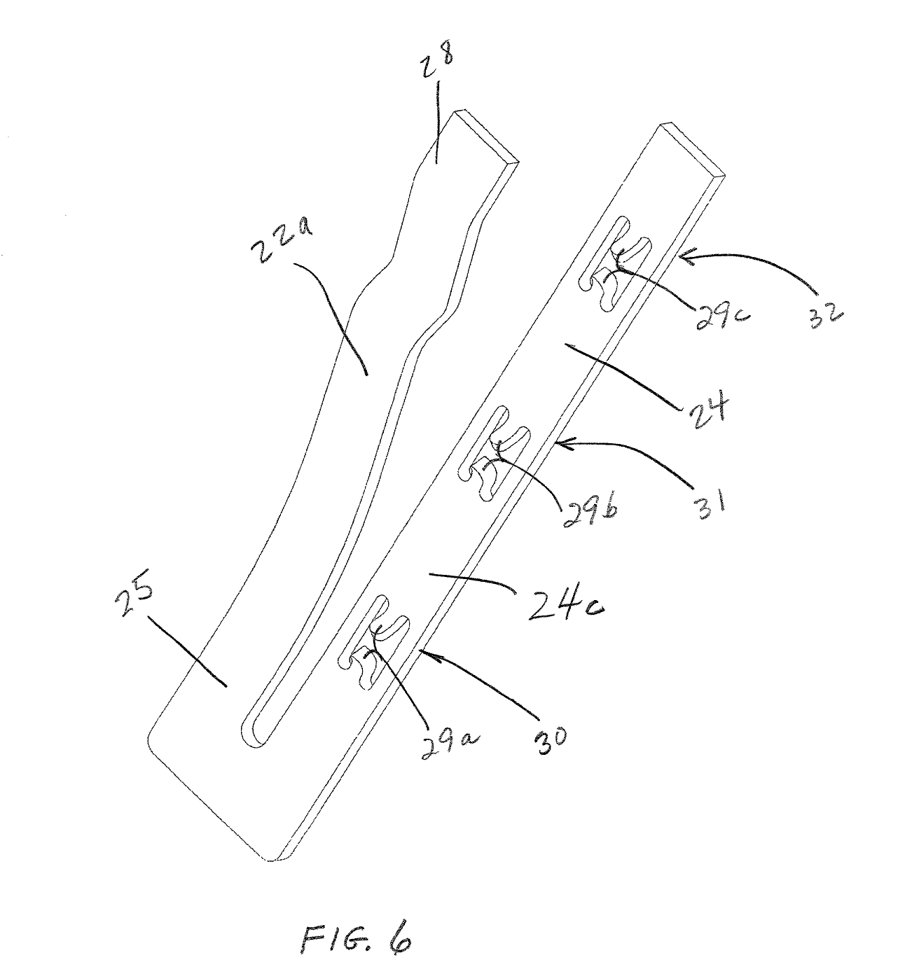

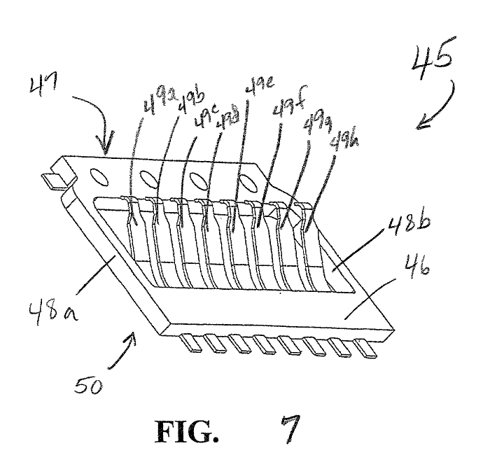

FIG. 6 shows the elongated contact beam 22a, connected to a base portion 24 of a contact. The first end 25 and the second end 28 of the elongated contact beam 22a are shown. Furthermore, first molding point 30, second molding point 31, and third molding point 32 are shown along the length of the base portion 24 of the contact. Retention nubs 29a-c are provided for either mechanical connection to the insulator 23, or in some embodiments provide a connection to the insulator 23 (insulator 23 is not shown in FIG. 6).

Turning to FIG. 7, a low profile stacker connector 45 is provided having an uppermost face 47 on its top portion and a bottommost face 50 on its lower portion. An insulating body base portion 46 is bounded by side 48a and side 48b. Further, connector elements 49a-h are provided in a generally parallel fashion and flexibly sprung upwards from the plane of the insulating body base portion 46.

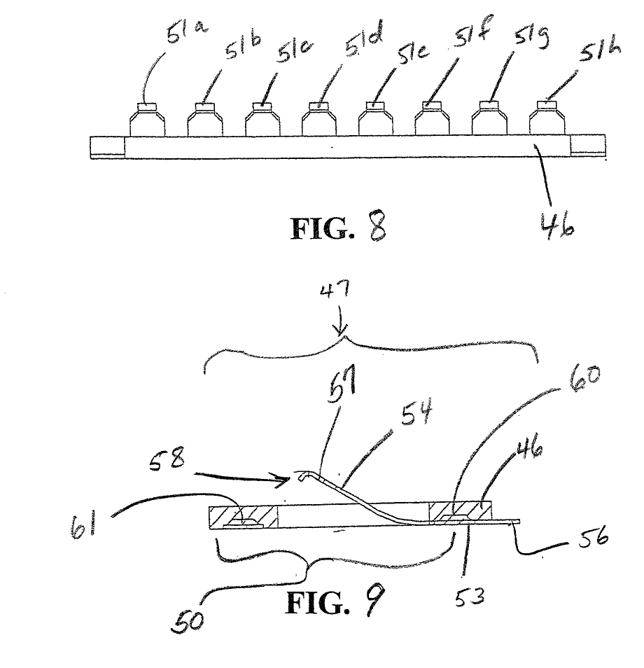

In FIG. 8, an end view of the low profile stacker connector 45 shown in FIG. 7 is seen. In the end view, the insulating body base portion 46 is shown below, and contact feet 51a-h are shown in a parallel row along the top surface. The contact feet 51 a-h comprises the distal end of the connector elements 49a-h which are shown in FIG. 7.

In FIG. 9, a side cross-sectional view of the connector shown in FIG. 8 is seen, comprising an uppermost face 47 and a bottommost face 50. The contact foot 54 is sprung outward and away from the insulating body base portion 46. The contact foot comprises a first end 56 and a second end 57. The first end 56 is securely mated with the insulating body base portion 46 at first molding point 60. Furthermore, a second molding point 61 provides additional connection between the metallic portion of the device and the insulating body base portion 46. At the distal end of the contact foot 54 is the contact head 58, which may be straight, or curved in a downward direction. In other embodiments, it may be curved in an upward direction, according to the style of contact required with the mating device. In any event, the contact foot 54 is positioned for resiliently engaging an electrical component that is pushed against the contact foot 54 which presses it downward towards the plane of the low profile stacker connector 45, thereby providing a mating force to provide electrical conductivity in the connector 45.

It is understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

What is claimed is:

1. A low profile electrical connector for interconnecting electrical components, comprising:
(a) at least one electrical contact, the contact comprising
i) an elongated beam portion, and
ii) a base portion, the base portion being provided in a first plane,
iii) the elongated beam portion being provided at a deviation angle from said first plane, the elongated beam portion further comprising a first end and a second end, the contact beam portion being held in a fixed position at its first end near the base portion;
(b) an insulator, the insulator being molded into the base portion of the contact, whereby the base portion of the contact is secured to the insulator at a plurality of molding points;
(c) whereby at least part of the elongated beam portion of the electrical contact is flexibly sprung at a deviation angle from the first plane of the base portion, the second end of the elongated beam portion being adapted for flexible engagement with an electrical component.

2. The connector of claim 1 in which the elongated beam portion of the contact comprises at least one cantilever beam.

3. The connector of claim 2 in which the insulator further comprises a stop, wherein at least one cantilever beam is held in tension against a stop.

4. The connector of claim 3 in which the cantilever beam is capable of moving from an undeflected position against a stop to a deflected position that is approximately parallel with the first plane of the base portion of the contact.

5. The connector of claim 1 in which the base portion of the contact comprises at least one molding point that represents a hole in the base portion of the contact, the hole being adapted secure connection of the contact to the insulator.

6. The connector of claim 5 in which the base portion of the contact is comprises of a first and a second parallel strip, wherein said molding points are provided along a first strip.

7. The connector of claim 6 in which the insulator further comprises at least one mounting aperture adapted to provide for mounting a connector to an electronic device.

8. The connector of claim 1 in which said stop comprises an elongated stop bar that is adapted to provide a stop for a plurality of cantilever beams.

9. The connector of claim 3 in which the elongated stop bar is oriented approximately perpendicular to the cantilever beam.

10. A low profile electrical connector for interconnecting electrical components, comprising:
(a) an electrical contact, the contact comprising
(i) an elongated beam portion having a plurality of cantilever beams arranged generally in parallel, the cantilever beams each having a first end and a second end, whereby the second end of said beams is adapted to flexibly engage an electronic component, and
(ii) a base portion, the base portion being provided in a first plane, whereby a first end of said cantilever beams is secured to the base portion; and
(b) an insulator, the insulator being molded into the base portion of the contact at a plurality of molding points, the insulator further comprising parallel struts separated by channels, said channels being adapted to provide a pathway for said elongated beams to flex, when contacted by an electronic component, from a first undeflected position to a second deflected position.

11. The low profile electrical connector of claim 10 in which the electrical contact is metallic.

12. The connector of claim 11 in which the electrical contact is comprised of beryllium copper.

13. The connector of claim 11 in which the electrical contact is comprised of a plated or conductive plastic.

14. The connector of claim 10 in which the insulator is comprised of a material selected from the following: molded thermoplastics and nonconductive materials.

15. The connector of claim 10 in which the cantilever beams comprise a contact nose.

16. The connector of claim 10 in which the base portion and the cantilever beam portion of the connector are stamped from a single carrier strip.

17. The connector of claim 10 in which a plurality of holes in said base portion are filled with molded thermoplastic to form an integrated base unit of the connector.

18. The connector of claim 10 in which the cantilever beams are capable of flexing within said channels from a location at which they are essentially parallel with the first plane to a second location at which they are held from further movement by a stop.

19. The connector of claim 18 in which at least one cantilever beam is pre-loaded with tension such that said cantilever beam is held against the stop in the undeflected position.

20. The connector of claim 18 in which the connector is a battery connector, in which the cantilever beam is adapted for receiving pressing contact from the terminal of a battery in moving from the undeflected position to the deflected position.

21. The connector of claim 18 in which the cantilever beams are capable of flexing independently from one another.

22. An electrical connector for interconnecting at least a first circuit board to a second circuit board, comprising:
an insulating body base portion having an upper portion defining an uppermost face configured for disposition adjacent a bottommost face, and longitudinal sides, a plurality of connector elements disposed on said connector, each said connector element having a first end and a second end, and further comprising;
a contact foot defined generally at said second end and extending from said uppermost face and disposed for contact mounting to a first circuit board;
a generally horizontal mounted portion intermediate adjacent said first end and mounted directly for contact with a second circuit board,
a resiliently movable contact head defined generally at said first end and disposed above a plane of said uppermost first face, said contact head movable towards said uppermost first face upon being pressed into mating contact with the first circuit board: and
whereby at lest a part of the connector element portion is flexibly sprung at an angle from the plane of the base portion, the connector element being adapted to flex while engaging a first circuit board;
whereby the insulating body base portion is molded to the connector element at at least one molding point.

23. The connector as in claim 21, wherein said bottommost face of said insulating body is configured for disposition adjacent a face of the second circuit board, said connector thereby disposed between the first and second circuit boards.
